(19) United States
(12) Patent Application Publication
(10) Pub. No.: US 2025/0222791 A1
(43) Pub. Date: Jul. 10, 2025

(54) METHOD FOR OPERATING A VEHICLE HAVING A FUEL CELL SYSTEM, AND FUEL CELL SYSTEM FOR SAME

(71) Applicant: ZF CV Systems Global GmbH, Bern (CH)

(72) Inventor: Janik Ricke, Uetze (DE)

(21) Appl. No.: 19/089,968

(22) Filed: Mar. 25, 2025

Related U.S. Application Data
(63) Continuation of application No. PCT/EP2023/074562, filed on Sep. 7, 2023.

(30) Foreign Application Priority Data
Sep. 29, 2022 (DE) 10 2022 125 104.7

(51) Int. Cl. B60L 50/72; B60L 58/30; H01M 8/04111; H01M 8/04119; H01M 8/04223; H01M 8/04225; H01M 8/04302; H01M 8/04303; H01M 8/04746

(52) U.S. Cl. CPC B60L 50/72; B60L 58/30; H01M 8/04111; H01M 8/04164; H01M 8/04225; H01M 8/04231; H01M 8/04302; H01M 8/04303; H01M 8/04753; H01M 2250/20

(57) ABSTRACT

A method is for operating a vehicle with a fuel cell system having a cathode-side flow path, connected in a fluid-conducting manner to the surroundings, for transporting air from the surroundings toward the fuel cell system, and for transporting a cathode off-gas from the fuel cell system into the surroundings, and a fluid-conducting component connected in a fluid-conducting manner to the cathode-side flow path and being configured to receive accumulations of condensate from the air or the cathode off-gas. The vehicle has a compressed air supply independent of the fuel cell system and is configured to provide dry compressed air. The method includes injecting the dry compressed air via the compressed air supply into the cathode-side flow path such that the fluid-conducting component is flowed through by the dry compressed air and existing air or existing cathode off-gas and/or condensate is displaced from the fluid-conducting component toward the surroundings.

### CROSS-REFERENCE TO RELATED APPLICATIONS

This application is a continuation application of international patent application PCT/EP2023/074562, filed Sep. 7, 2023, designating the United States and claiming priority from German application 10 2022 125 104.7, filed Sep. 29, 2022, and the entire content of both applications is incorporated herein by reference.

### TECHNICAL FIELD

The disclosure relates to a method for operating a vehicle, in particular a utility vehicle, with a fuel cell system, wherein the fuel cell system has a cathode-side flow path, connected in a fluid-conducting manner to the surroundings, for transporting air from the surroundings (U) toward the fuel cell system, and for transporting a cathode off-gas from the fuel cell system into the surroundings (U), and a fluid-conducting component which is connected in a fluid-conducting manner to the cathode-side flow path and is configured to receive accumulations of condensate from the air or the cathode off-gas, and the vehicle has a compressed air supply which is independent of the fuel cell system and is configured to provide dry compressed air.

### BACKGROUND

Methods of the abovementioned type are well known. In the course of the energy revolution, hydrogen is an energy form which is increasingly gaining in significance in the automotive sector and, in particular, also in the utility vehicle sector. A central challenge in the operation of fuel cell systems is the degree of efficiency during operation of the fuel cell system and the stability of the fuel cell system. Within the fuel cell system, compressor arrangements perform the provision of oxygen (air) as cathode-side reactant, and expander arrangements perform the discharge of the cathode off-gas which leaves the fuel cell, wherein the compressor and the expander are not necessarily, but frequently, configured as integrated structural units.

After passing through the fuel cell, the cathode off-gas has a substance mixture of water and air, in which both water in droplet form and water which is bound in the air with a high degree of saturation are situated. Before passing through the fuel cell of the fuel cell system, moisture can likewise be present in the ambient air which enters into the cathode-side flow path.

During the transport of the air and/or the cathode off-gas through the flow path, cooling of the air and/or the cathode off-gas can occur in part during operation, but above all also following operation, of the fuel cell system, as a result of which water condenses out. A pressure drop in the flow path also leads to condensing out of water from the air or the cathode off-gas.

Although undesired, there are necessarily always locations within the flow path at the fluid-conducting components of the fuel cell system, in which locations condensate can collect. Insofar as reference is made in the present case to the fact that a fluid-conducting component is configured to receive accumulations of condensate from the air or the cathode off-gas, this is to be understood to mean that, on account of the spatial or technical requirements, the components also undesirably have regions, in which condensate can collect and in this sense is received by the component.

Water can lead in the long-term to corrosion, but at any rate also to increased friction in the case of movable fluid-conducting components, and can have a disadvantageous effect on the degree of efficiency and/or the stability of the fluid-conducting components and therefore on the fuel cell system as a whole. If the condensate freezes within the fluid-conducting components, damage of the components and, in the worst case, a functional failure of the fuel cell system are threatened.

Approaches are known from the prior art, in which approaches it has been proposed to further operate the compressor arrangements of the fuel cell system following operation of the fuel cell system, in order to dry the fuel cell itself. Systems of this type are described, for example, in DE102020202283 A1 or DE102019214748 A1.

It has been shown, however, that drying by way of the compressors inherent to the system cannot guarantee that no water actually accumulates at critical locations in the cathode-side flow path.

### SUMMARY

It is an object of the disclosure to overcome the above-described disadvantages as far as possible in a method. In particular, the disclosure was based on an object of specifying a method which makes more reliable drying of the fluid-conducting components of the fuel cell system possible.

This object is achieved via various embodiments of the disclosure. It is proposed, in particular, that a method includes a step of injecting the compressed air via the compressed air supply into the cathode-side flow path, in such a way that the fluid-conducting component is flowed through by the compressed air, and existing air and/or existing cathode off-gas and/or condensate are/is displaced from the fluid-conducting component in the direction of the surroundings.

If dry compressed air is mentioned in conjunction with the disclosure, this is to be understood to mean compressed air which lies in class 6 or higher, preferably in class 4 or higher, in accordance with ISO 8573-1:2010.

The disclosure is based on the finding that, in the prior art, moisture is still situated after operation in the air driven through the fuel cell via the compressor, which moisture can condense as a consequence of environmental influences, above all cooling of the system, and/or the surroundings, and can accumulate at the corresponding locations in the fluid-conducting components.

The disclosure comes into play here and utilizes the circumstance that a compressed air supply with dried compressed air is already present in the (utility) vehicle, in which the method designated at the outset is used, because it is required, for example, for a brake system and/or an air suspension system of the (utility) vehicle. Instead of the air which might be provided by any compressor arrangement of the fuel cell system and which always introduces a certain residual moisture from the surroundings into the system, the disclosure proposes using the dry compressed air, already prepared in a technical manner, of the compressed air supply, and injecting this compressed air into the flow path in such a way that the moisture, still situated in the system, of the air or the cathode off-gas is expelled, and any accumulations of condensate which are situated within the fuel cell system are entrained and expelled from the system.

Here, the disclosure exploits the fact that the compressed air supply of the utility vehicle is anyway configured to provide compressed air at an operating pressure which is considerably higher than that pressure which any compressor arrangements of the fuel cell system would provide, and that this can already be injected in sufficiently high mass flows into the flow path without additional pressurization, in order to ensure entraining of the condensate accumulations. The necessary operating parameters of pressure and mass flow can be determined empirically in simple pilot tests, and the quantity of the dry compressed air to be injected can be calibrated in a widely known way.

Therefore, the disclosure proposes a solution which can be used for all fluid-conducting components of the fuel cell system if the respective fluid-conducting component can be structurally reached by compressed air lines.

The disclosure makes it possible, and provides in preferred embodiments, that one or more fluid-conducting components can be freed from moisture at the same time or sequentially by injecting compressed air.

In one preferred embodiment of the disclosure, the method includes the step of starting up the fluid-conducting component, wherein the step of injecting the dry compressed air is started temporally before, or at the same time as, the starting up.

The compressed air supply is preferably configured to provide dry compressed air at an operating pressure of 8.0 bar or more, and the method includes the step of reducing the pressure for injecting to an injection pressure of 6.0 bar or less, preferably in a range from 3.0 bar to 5.5 bar. It has been proven that the reduction in the pressure involves an improved discharge of moisture and particulates in comparison with the operating pressure which the compressed air supply usually provides and which as a rule lies above 8.0 bar. In particular, the injection is carried out at this reduced injection pressure and at the same time the maximum available volumetric flow is carried out at the injection pressure, in order to achieve an entraining effect which is as high as possible.

The step of injecting the dry compressed air is preferably started and also concluded temporally before starting up the fluid-conducting component. This can ensure that the operation of the fuel cell system is free from adverse effects as a result of air humidity or condensate.

In a further preferred embodiment, the method additionally includes a step of shutting down the fluid-conducting component, wherein the step of injecting the compressed air is started temporally after, or at the same time as, shutting down. Depending on the ambient conditions, it can be advantageous for the step of injecting the dry compressed air to be performed as soon as possible after shutting down the fluid-conducting component or at the same time as shutting down the fluid-conducting component.

The disclosure can also advantageously be used, however, if a certain time is first of all waited before injecting the compressed air and after shutting down the fluid-conducting component, in order that a certain cooling action of the system can take place. This also prevents the injecting of the dry compressed air into the cathode-side flow path from being able to have a negative influence on the operation of the fuel cell system.

The step of injecting dry compressed air is particularly preferably carried out after shutting down the fluid-conducting component, additionally in a method which also includes injecting of dry compressed air before starting up the fluid-conducting component.

In a further preferred embodiment of the method, the step of injecting the dry compressed air takes place for a predefined purging duration which preferably lies in a region of five seconds or longer, further preferably in a region of ten seconds or longer, and particularly preferably in a region of 15 seconds or longer.

The preferred regions which are designated above are limited toward the top in a further preferred embodiment by a maximum purging duration of 30 seconds or fewer.

The purging duration is further preferably not longer than 20 seconds. It has been proven that, after the abovementioned purging durations have elapsed, there is no residual moisture or only such a low residual moisture in the system that a disadvantageous impairment of the fuel cell system operation is reliably ruled out.

Continuing the purging operation beyond this time would no longer achieve a measurable advantage. Therefore, limiting the maximum purging duration saves resources without a disadvantageous effect.

In a further preferred embodiment, the fluid-conducting component has an expander stage of a compressor arrangement of the fuel cell system which preferably has an expander chamber and/or an expander wheel. As an alternative or in addition, the fluid-conducting component has an air bearing arrangement of a compressor arrangement of the fuel cell system, which air bearing arrangement preferably has one or more air bearings which are connected in a fluid-conducting manner to the expander stage. As an alternative or in addition, the fluid-conducting component has a condensate separator of the fuel cell system. The condensate separator is preferably arranged in the cathode-side flow path of the cathode off-gas, that is, for example, downstream of the fuel cell but upstream of an expander stage. At least the droplets can be removed from the existing water proportion in the cathode off-gas by way of the condensate separator, also called a droplet separator. Injecting compressed air into the condensate separator improves and accelerates the discharge of moisture from that component, just as from the other abovementioned components. The risk of damage in winter as a consequence of freezing is also advantageously reduced here.

As an alternative or in addition, the fluid-conducting component has a compressor stage of a compressor arrangement of the fuel cell system, which compressor stage preferably has an expander chamber and/or an expander wheel. Even in the case of compressor stages of the abovementioned type, the risk of damage on account of moisture and/or particulate accumulation is advantageously reduced by injecting dry compressed air. To this end, the compressor stage preferably has corresponding outlet bores which can be opened during the injection, and can be closed during the operation of the fuel cell system. In a further preferred embodiment, the compressed air supply is assigned to a pneumatic brake system of the vehicle, in particular a multiple-circuit brake system. In the case of the assignment to the multiple-circuit brake system, the compressed air supply is preferably connected to an auxiliary consumer circuit of the brake system.

The disclosure has been described above on the basis of a first aspect with reference to the method according to the disclosure. In a second aspect, furthermore, the disclosure relates to a fuel cell system for driving a vehicle, in particular a utility vehicle, which fuel cell system has a compressed air supply which is independent of the fuel cell system and is configured to provide dry compressed air, wherein the fuel cell system has a cathode-side flow path which is connected in a fluid-conducting manner to the surroundings for transporting air from the surroundings toward the fuel cell system, and for transporting a cathode off-gas from the fuel cell system into the surroundings, and a fluid-conducting component which is connected in a fluid-conducting manner to the flow path and is configured to receive accumulations of condensate from the air or the cathode gas.

The disclosure also achieves the object already depicted at the outset for the method in a fuel cell system of the abovementioned type by the fuel cell system having a valve arrangement which can be switched to and fro between a shut-off position and a release position, wherein the valve arrangement is connected in a fluid-conducting manner to the cathode-side flow path in the release position and is configured to connect the compressed air supply to the flow path in the release position for injecting compressed air into the cathode-side flow path in such a way that the fluid-conducting component is flowed through by the compressed air, and existing air or existing cathode off-gas and/or condensate are/is displaced from the fluid-conducting component in the direction of the surroundings.

With regard to the fuel cell system, the disclosure utilizes the same advantages as the method according to the disclosure of the first aspect. Preferred embodiments of the method are at the same time preferred embodiments of the fuel cell system of the second aspect, and vice versa, for which reason reference is also made to the above comments in order to avoid repetitions, and also to the following comments with respect to the fuel cell system with regard to the preferred embodiments of the method.

In one preferred embodiment of the fuel cell system, the valve arrangement can be actuated, and is configured to be connected in a signal-conducting manner to a control unit, wherein the control unit is preferably configured as a brake control unit or trailer brake control unit.

The control unit is preferably constructed in a generally known way, that is, it has processor means and one or more data memories, and is configured to at any rate partially carry out the method according to the disclosure. The control unit is preferably configured to control the injection of compressed air into the cathode-side flow path in the method of the first aspect by way of actuation of the valve arrangement.

The valve arrangement can be actuated pneumatically, electrically, electro-pneumatically or hydraulically.

Depending on whether one or more fluid-conducting components in the fuel cell system are to be freed from moisture by injecting compressed air, the valve arrangement can include one or more one-way or multiple-way valves which can be actuated. The valve arrangement is configured in preferred embodiments to actuate one or more of these valves simultaneously or individually, in order to free the respective fluid-conducting components which are connected in a fluid-conducting manner to the valves of the valve arrangement from moisture.

In a further aspect, the disclosure relates to a vehicle, in particular a utility vehicle, with a fuel cell system in accordance with one of the above-described preferred embodiments, and a control unit which is connected in a signal-conducting manner to the valve arrangement and is configured to actuate the valve arrangement for injecting the compressed air in a method in accordance with one of the above-described preferred embodiments, wherein the control unit is preferably configured as a control unit or trailer control unit.

The vehicle utilizes the same advantages as the fuel cell system according to the disclosure of the second aspect and the method according to the disclosure of the first aspect. Preferred embodiments of the method and the fuel cell system are therefore at the same time also preferred embodiments of the vehicle, and vice versa, for which reason reference is made to the above comments in order to avoid repetitions.

### BRIEF DESCRIPTION OF DRAWINGS

The invention will now be described with reference to the drawings wherein:

FIG. 1 shows a diagrammatic view of a vehicle with the fuel cell system in accordance with one preferred embodiment; and,

FIG. 2 shows a diagrammatic view of one preferred embodiment of the method according to the disclosure for operating a vehicle according to FIG. 1.

### DETAILED DESCRIPTION

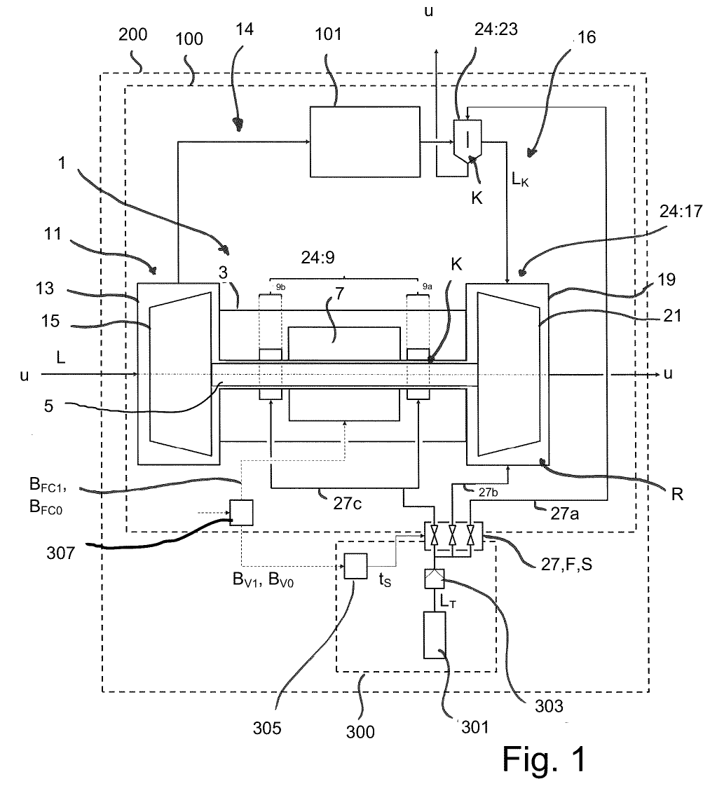

FIG. 1 diagrammatically shows a vehicle 200, in particular a utility vehicle. The vehicle 200 has a fuel cell system 100 and a brake system 300.

The fuel cell system 100 has a fuel cell 101 which is supplied on the cathode side with air L by a compressor arrangement 1. The compressor arrangement 1 has a compressor housing 3, in which a rotor shaft 5 is arranged. The rotor shaft 5 is driven via an electric machine 7, and is mounted in a contact-free manner by an air bearing arrangement 9. The air bearing arrangement 9 has a plurality of air bearings, of which a first radial air bearing 9a and a second radial air bearing 9b are shown here by way of example. The air bearing arrangement 9 expediently also has one or more axial air bearings which are not relevant for understanding the disclosure, however, and are therefore hidden for improved clarity in FIG. 1.

The compressor arrangement 1 has a compressor stage 11, with a compressor chamber 13 and a compressor impeller 15 which is arranged therein and, as a result of a rotation of the rotor shaft 5, sucks in air L from the surroundings U, compresses it and conveys it via a (first) cathode-side flow path 14 for feeding reactant to the fuel cell 101.

After conversion in the fuel cell 101, a cathode off-gas L_{K} is conveyed via a (second) cathode-side flow path 16 to an expander stage 17 which has an expander chamber 19 and an expander wheel 21 arranged therein. The cathode off-gas L_{K} is expanded via the expander wheel 21 in the expander chamber 19 and is subsequently conveyed further to the surroundings U.

A condensate separator 23 which is configured to collect water in droplet form and any further accumulating condensate K and to discharge it from the cathode off-gas L_{K}, preferably also in the direction of the surroundings U, is arranged in the cathode-side flow path 16 between the fuel cell 101 and the expander stage 17.

Condensate K can accumulate not only in the condensate separator 23, but rather also in further regions of the flow path 16, for example within the expander chamber 19, and also within the air bearing arrangement 9 which, due to its construction on account of the contactless bearing system, is connected in a fluid-conducting manner to the flow path 16 and there first of all to the expander chamber 19. Therefore, the potential presence of condensate K is also indicated by way of example in these regions of the fuel cell system 100.

The condensate separator 23, the expander stage 17 and the air bearing arrangement 9 are therefore to be understood by way of example to be fluid-conducting components 24.

The vehicle 200 has a valve arrangement 25 which is connected to the fluid-conducting components 24 in a fluid-conducting manner via respective dedicated fluid lines 27a, 27b, 27c.

The valve arrangement 25 can be assigned structurally to the fuel cell system 100, but it can also optionally be assigned structurally to the brake system 300, depending on the installation conditions and customer requirements. The valve arrangement 25 can also be arranged as a dedicated valve arrangement at a favorable location in the vehicle 200 separately both with respect to the brake system 300 and with respect to the fuel cell system 100. The functional assignment is decisive. The valve arrangement 25 can optionally be configured in such a way that it has one or more multiway valves, or respective dedicated single valves.

The valve arrangement 25 can be switched to and fro between a release position F and a shut-off position, and is configured to establish a fluid-conducting connection between a compressed air supply 301 of the brake system 300 and the fluid-conducting components 24 in the cathode-side flow path 16 in the release position F, with the result that dry compressed air L_{T} can be injected into the cathode-side flow path 16 and, in particular, into the fluid-conducting components 24. As a result, the dry compressed air L_{T} displaces the potentially moisture-afflicted air of the condensate off-gas L_{K} and also expels any accumulated condensate K from the fluid-conducting components 24.

The brake system preferably has a particulate filter 303 which is connected upstream of the valve arrangement 25.

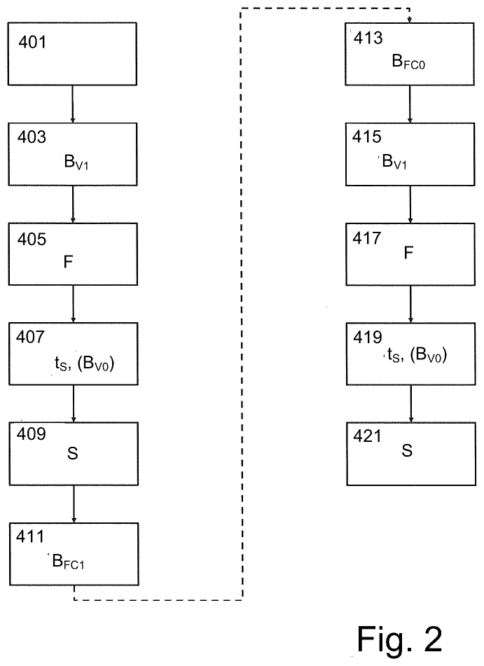

The brake system 300 has a (first) control unit 305 which is preferably configured as a brake control unit or a trailer brake control unit which is configured to switch the valve arrangement 25 for a predefined purging duration t_{S} from the shut-off position S into the release position F and vice versa, in order to carry out a targeted injection operation in order to dry the fluid-conducting components 24. To this end, the control unit 305 is connected in a signal-conducting manner to a (second) control unit 307, for example a compressor controller or fuel cell controller, and is configured such that it can be actuated by the latter. This makes it possible in a simple way that, when, by starting up or shutting down the compressor arrangement 1, a plurality or all of the fluid-conducting components 24 should likewise be started up or shut down, an actuation of the valve arrangement 25 can always be performed in order to dry the fluid-conducting components 24, preferably on the basis of the method according to the disclosure which will be explained in the following text on the basis of FIG. 2.

In FIG. 1, the method of operation of the disclosure has been explained with a focus on the fluid-conducting components 24 in the second cathode-side flow path 16. In a further preferred embodiment which is not depicted separately here for reasons of clarity, as an alternative or in addition the first cathode-side flow path 14 has a fluid-conducting component, for instance the compressor chamber 13 which is blown dry in the same way via injecting dry compressed air as the fluid-conducting components 24 in the second cathode-side flow path 16. Reference is made in this regard in an analogous manner to the above comments and the following comments.

FIG. 2 shows a diagrammatic method sequence, in which the dry compressed air L_{T} is injected via the compressed air supply 301 into the cathode-side flow path 16 in such a way that the fluid-conducting component 24 is flowed through by the compressed air L_{T}, and existing cathode off-gas L_{K} and/or condensate K are/is displaced from the fluid-conducting component 24 in the direction of the surroundings U.

In step 401, the starting point is first of all a start request for the fuel cell system 101. Proceeding from this start request, a control command B_{V1} is transmitted to the first control unit 305 by the second control unit 307 in step 403. Thereupon, the first control unit 305 actuates the valve arrangement 25 in order to assume the release position F in step 405.

In step 407, the valve arrangement 25 is then left in the release position for the purging duration T_{S}, and the fluid-conducting components 24 are dried by injecting the dry compressed air L_{T} into the flow path 16, until the valve arrangement 25 is transferred again into its shut-off position S (step 409) at the end of the purging duration T_{S}. This can optionally be triggered by a control command B_{V0} from the second control unit 307, or can be controlled automatically by the first control unit 305.

In step 411, after successfully shutting off the valve arrangement 25, the fuel cell system 100 is started up, preferably via a control command B_{FC1} of the second control unit 307.

If the fuel cell system 100 is to be shut off from running operation, a control command B_{FC0} is first of all transmitted during a stop request to the electric machine 7 of the compressor arrangement 1 in step 413, preferably triggered again by the control unit 307. This shuts off the operation and therefore shuts down the fluid-conducting components 24.

At the same time or with a short delay afterward, the control command B_{V1} is transmitted by the second control unit 307 to the first control unit 305 in step 415, whereupon the valve arrangement 25 assumes its release position F in step 417.

In step 419, the valve arrangement 25 can once again remain in its release position F for the duration t_{S} of the purging operation, in order to dry the cathode-side flow path 16 in the region of the fluid-conducting components 24, until the valve arrangement 25 again assumes its shut-off position S in step 421. This can be caused, as previously, by a control command B_{V0} of the second control unit 307, or can be controlled automatically by the first control unit 305.

The programming complexity for implementing the method is simple and efficient. The disclosure therefore provides an extremely effective and at the same time simply implemented system for increasing the stability and improving the degree of efficiency of the fuel cell system 100 of the vehicle 200.

In the embodiment of FIGS. 1 and 2, a compressor arrangement 1 of a fuel cell system 100 is shown, wherein the fuel cell system 100 has a plurality of fluid-conducting components 24 which can each (undesirably) accumulate condensate K. The disclosure is not restricted to the configuration which is shown, however, but rather is likewise in essence implemented by systems which have a smaller number of fluid-conducting components 24, or a greater number of fluid-conducting components 24.

It is understood that the foregoing description is that of the preferred embodiments of the invention and that various changes and modifications may be made thereto without departing from the spirit and scope of the invention as defined in the appended claims.

### LIST OF DESIGNATIONS (PART OF THE DESCRIPTION)

1 Compressor arrangement
3 Compressor housing
5 Rotor shaft
7 Electric machine
9 Air bearing arrangement
9a, 9b First and second air bearing
11 Compressor stage
13 Compressor chamber
14 Flow path
15 Compressor impeller
16 Flow path
17 Expander stage
19 Expander chamber
21 Expander wheel
23 Condensate separator
24 Fluid-conducting component
25 Valve arrangement
27a, b, c Fluid lines
100 Fuel cell system
101 Fuel cell
200 Vehicle
300 Brake system
301 Compressed air supply
303 Particulate filter
305 (First) control unit, brake system
307 (Second) control unit, fuel cell system
401 Step: start request
403 Step: actuating
405 Step: release position
407 Step: injecting dry compressed air
409 Step: shut-off position
411 Step: starting up the fluid-conducting components
413 Step: stop request, shutting down
415: Step: actuating
417 Step: release position
419 Step: injecting dry compressed air
421 Step. shut-off position
F Release position
K Condensate
L Air
L_{K} Cathode off-gas
L_{T} Compressed air
S Shut-off position
t_{S} Purging duration
U Surroundings
B_{FC0} Control command, compressor arrangement
B_{FC1} Control command, compressor arrangement
B_{V0} Control command, valve arrangement
B_{V1} Control command, valve arrangement

1. A method for operating a vehicle with a fuel cell system, wherein the fuel cell system has a cathode-side flow path, connected in a fluid-conducting manner to surroundings, for transporting air from the surroundings toward the fuel cell system, and for transporting a cathode off-gas from the fuel cell system into the surroundings, the fuel cell system further having a fluid-conducting component connected in a fluid-conducting manner to the cathode-side flow path and configured to receive accumulations of condensate from the air or from the cathode off-gas, and the vehicle has a compressed air supply which is independent of the fuel cell system and is configured to provide dry compressed air, the method comprising:
injecting the dry compressed air via the compressed air supply into the cathode-side flow path such that the fluid-conducting component is flowed through by the dry compressed air, and at least one of existing air, existing cathode off-gas, and the condensate are displaced from the fluid-conducting component in a direction of the surroundings.

2. The method of claim 1 further comprising starting up the fluid-conducting component, wherein said injecting the dry compressed air is started temporally before, or at the same time as, said starting up the fluid-conducting component.

3. The method of claim 1, further comprising starting up the fluid-conducting component, wherein said injecting the dry compressed air is started and concluded temporally before said starting up of the fluid-conducting component.

4. The method of claim 1 further comprising shutting down the fluid-conducting component, wherein said injecting the dry compressed air is started temporally after, or at the same time as, said shutting down the fluid-conducting component.

5. The method of claim 1, wherein said injecting the dry compressed air takes place for a predefined purging duration.

6. The method of claim 1, wherein said injecting the dry compressed air takes place for a predefined purging duration which lies in a region of at least one of: at least 5 seconds, at least 10 seconds, and at least 15 seconds.

7. The method of claim 1, wherein the fluid-conducting component has at least one of:
an expander stage of the compressor arrangement of the fuel cell system;
an air bearing arrangement of a compressor arrangement of the fuel cell system;
a condensate separator of the fuel cell system; and,
a compressor stage of the compressor arrangement of the fuel cell system.

8. The method of claim 1, wherein the compressed air supply is assigned to a pneumatic brake system of the vehicle.

9. The method of claim 1, wherein the compressed air supply is assigned to a multiple-circuit brake system.

10. The method of claim 1, wherein the vehicle is a utility vehicle.

11. A fuel cell system for driving a vehicle, wherein the fuel cell system is supplied by a compressed air supply which is independent of the fuel cell system and is configured to provide dry compressed air, the fuel cell system comprising:
a cathode-side flow path connected in a fluid-conducting manner to surroundings for transporting air from the surroundings toward the fuel cell system, and for transporting a cathode off-gas from the fuel cell system into the surroundings;
a fluid-conducting component which is connected in a fluid-conducting manner to said cathode-side flow path and being configured to receive accumulations of condensate from the air or the cathode off-gas;
at least one of the vehicle and the fuel cell system having a valve arrangement configured to be switched to and fro between a shut-off position and a release position; and,
the valve arrangement being connected in a fluid-conducting manner to said cathode-side flow path in the release position and being configured to connect the compressed air supply to said cathode-side flow path in the release position for injecting the dry compressed air into said cathode-side flow path such that said fluid-conducting component is flowed through by the dry compressed air, and at least one of existing air, existing cathode off-gas, and the condensate therefrom are displaced from said fluid-conducting component in a direction of the surroundings.

12. The fuel cell system of claim 11, wherein the valve arrangement is configured to be actuated, and is configured to be connected in a signal-conducting manner to a control unit.

13. The fuel cell system of claim 12, wherein the control unit is a brake control unit or trailer brake control unit.

14. The fuel cell system of claim 11, wherein the vehicle is a utility vehicle.

15. A vehicle comprising:
a compressed air supply;
a fuel cell system for driving the vehicle, wherein the fuel cell system is supplied by said compressed air supply which is independent of said fuel cell system and is configured to provide dry compressed air;
said fuel cell system including a cathode-side flow path connected in a fluid-conducting manner to surroundings for transporting air from the surroundings toward said fuel cell system, and for transporting a cathode off-gas from said fuel cell system into the surroundings;
said fuel cell system including a fluid-conducting component connected in a fluid-conducting manner to said cathode-side flow path and being configured to receive accumulations of condensate from the air or the cathode off-gas;
a valve arrangement configured to be switched to and fro between a shut-off position and a release position;
said valve arrangement being connected in a fluid-conducting manner to said cathode-side flow path in said release position and being configured to connect said compressed air supply to said cathode-side flow path in said release position for injecting the dry compressed air into said cathode-side flow path such that said fluid-conducting component is flowed through by the dry compressed air, and at least one of existing air, existing cathode off-gas, and the condensate therefrom are displaced from said fluid-conducting component in a direction of the surroundings; and,
a control unit connected in a signal-conducting manner to said valve arrangement and being configured to actuate said valve arrangement for injecting the dry compressed air by injecting the dry compressed air via the compressed air supply into the cathode-side flow path such that the fluid-conducting component is flowed through by the dry compressed air, and at least one of the existing air, the existing cathode off-gas, and the condensate are displaced from the fluid-conducting component in a direction of the surroundings.

16. The vehicle of claim 15, wherein the vehicle is a utility vehicle.

17. The vehicle of claim 15, wherein the valve arrangement is part of said fuel cell.

18. The vehicle of claim 15, wherein said control unit is a brake control unit or a trailer brake control unit.
